(19) United States
(12) Patent Application Publication
(10) Pub. No.: US 2025/0097869 A1
(43) Pub. Date: Mar. 20, 2025

(54) FLEXIBLE SYNCHRONIZATION SIGNAL AND SYSTEM INFORMATION TRANSMISSIONS

(71) Applicant: Samsung Electronics Co., Ltd., Suwon-si (KR)

(72) Inventor: Jeongho Jeon, San Jose, CA (US)

(21) Appl. No.: 18/826,081

(22) Filed: Sep. 5, 2024

Related U.S. Application Data
(60) Provisional application No. 63/539,265, filed on Sep. 19, 2023.

(51) Int. Cl. H04W 56/00; H04W 76/28

(52) U.S. Cl. CPC H04W 56/0015; H04W 76/28

(57) ABSTRACT

Methods and apparatuses for flexible synchronization signal and system information transmission in wireless communication systems are provided. A method for a user equipment (UE) includes receiving information related to: a synchronization signal block (SSB) with an adaptation of periodicity or availability, an on-demand SSB, or an on-demand system information block (SIB). The method further includes receiving, on a cell, the SSB with the adaptation of periodicity or availability, the on-demand SSB, or the on-demand SIB and determining synchronization or system information on the cell.

### CROSS-REFERENCE TO RELATED APPLICATIONS AND CLAIM OF PRIORITY

The present application claims priority to U.S. Provisional Patent Application No. 63/539,265, filed on Sep. 19, 2023. The contents of the above-identified patent documents are incorporated herein by reference.

### TECHNICAL FIELD

The present disclosure relates generally to wireless communication systems and, more specifically, the present disclosure relates to flexible synchronization signal and system information transmission in wireless communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to flexible synchronization signal and system information transmission in wireless communication systems.

In one embodiment, a method for a user equipment (UE) is provided. The method includes receiving information related to: a synchronization signal block (SSB) with an adaptation of periodicity or availability, an on-demand SSB, or an on-demand system information block (SIB). The method further includes receiving, on a cell, (i) the SSB with the adaptation of periodicity or availability, (ii) the on-demand SSB, or (iii) the on-demand SIB and determining synchronization or system information on the cell.

In another embodiment, a user equipment (UE) is provided. The UE includes a transceiver configured to receive information related to: a SSB with an adaptation of periodicity or availability, an on-demand SSB, or an on-demand SIB. The transceiver is further configured to receive, on a cell, (i) the SSB with the adaptation of periodicity or availability, (ii) the on-demand SSB, or (iii) the on-demand SIB. The UE further includes a processor operably coupled with the transceiver, the processor configured to determine synchronization or system information on the cell.

In yet another embodiment, a base station (BS) is provided. The BS includes a processor and a transceiver operably coupled with the processor. The transceiver is configured to transmit information related to: a SSB with an adaptation of periodicity or availability, an on-demand SSB, or an on-demand SIB; and transmit (i) the SSB with the adaptation of periodicity or availability, (ii) the on-demand SSB, or (iii) the on-demand SIB.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to various embodiments of the present disclosure;

FIG. 2 illustrates an example of gNB according to various embodiments of the present disclosure;

FIG. 3 illustrates an example of UE according to various embodiments of the present disclosure;

FIGS. 4 and 5 illustrate example of wireless transmit and receive paths according to various embodiments of the present disclosure;

FIG. 6 illustrates an example of antenna structure according to various embodiments of the present disclosure;

FIG. 7 illustrates an example of a cell DTX/DRX according to various embodiments of the present disclosure;

FIG. 8 illustrates an example of a cell DTX/DRX activation/deactivation on a cell according to various embodiments of the present disclosure;

FIG. 9 illustrates an example method performed by a UE for receiving multiple different types of SSBs and/or SIBs according to various embodiments of the present disclosure;

FIG. 10 illustrates an example of network adaptation with multiple different types of SSBs and/or SIBs according to various embodiments of the present disclosure;

FIG. 11 illustrates an example method performed by a UE for initiating cell activation according to various embodiments of the present disclosure;

FIG. 12 illustrates a signaling flow for UE-initiated cell reactivation according to various embodiments of the present disclosure;

FIG. 13 illustrates an example of transmission of UL WUS of UE and response of gNB 1300 according to various embodiments of the present disclosure; and

FIG. 14 illustrates an example method performed by a UE in a wireless communication system according to embodiments of the present disclosure.

### DETAILED DESCRIPTION

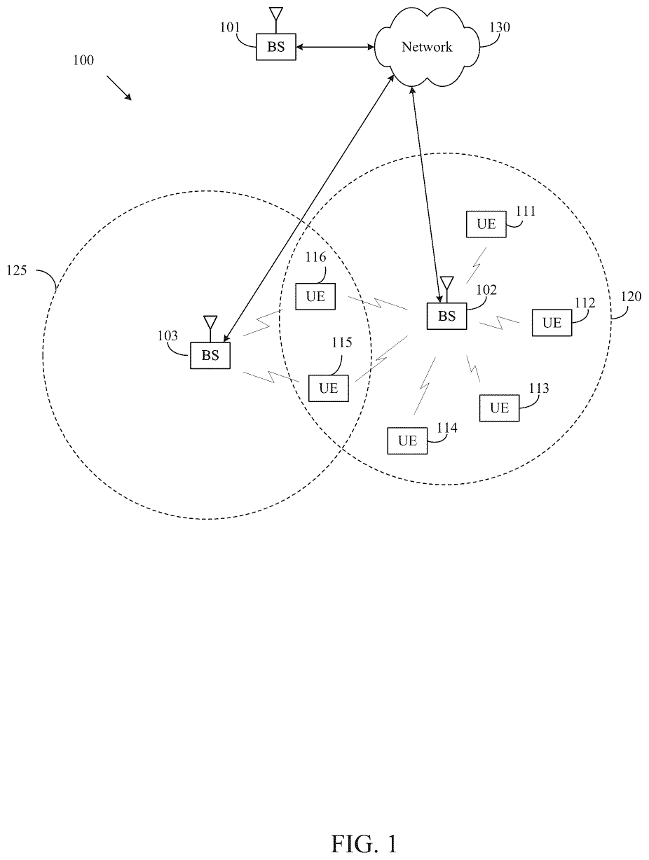

FIG. 1 through FIG. 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.5.0, “NR; Physical channels and modulation”; 3GPP TS 38.212 v17.5.0, “NR; Multiplexing and channel coding”; 3GPP TS 38.213 v17.6.0, “NR; Physical layer procedures for control”; 3GPP TS 38.214 v17.6.0, “NR; Physical layer procedures for data”; 3GPP TS 38.331 v17.5.0, “NR; Radio Resource Control (RRC) protocol specification”; and 3GPP TS 38.321 v17.5.0, “NR; Medium Access Control (MAC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the gNBs 101-103 includes circuitry, programing, or a combination thereof, to support flexible synchronization signal and system information transmission in wireless communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

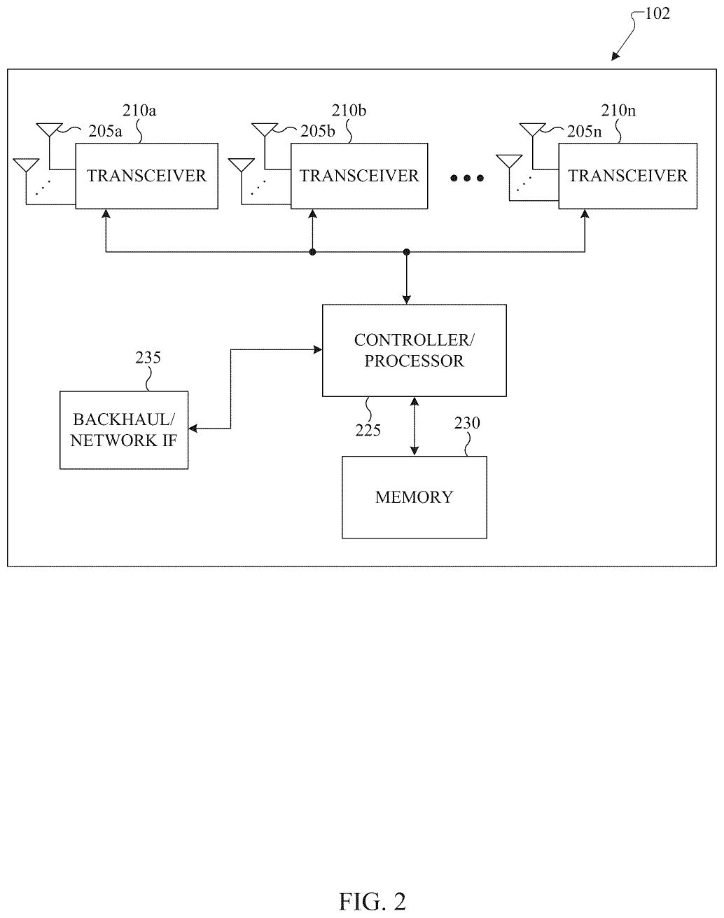

FIG. 2 illustrates an example gNB 102 according to various embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support flexible synchronization signal and system information transmission in wireless communication systems. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a wireless communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

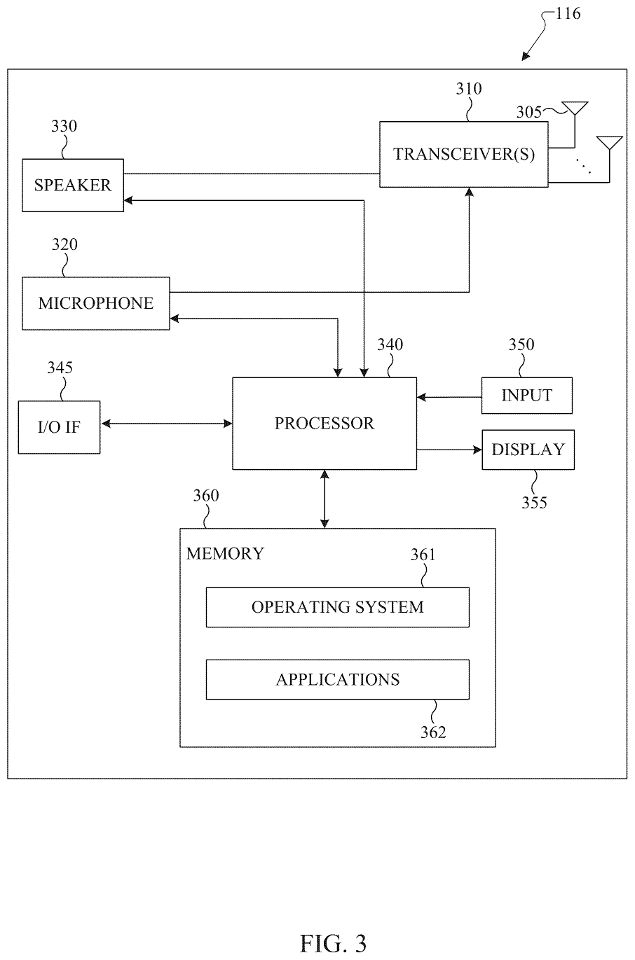

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to support flexible synchronization signal and system information transmission in wireless communication systems. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

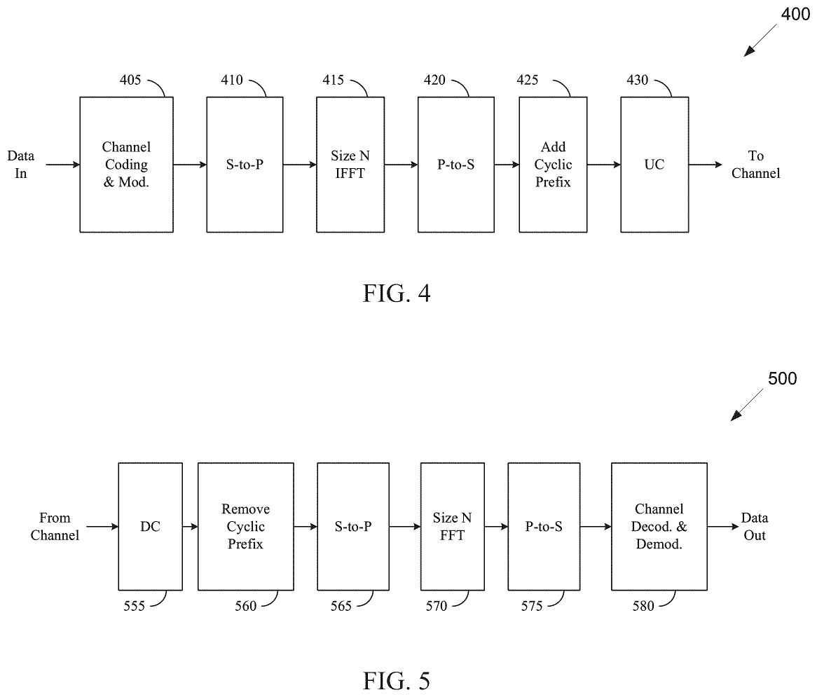

FIG. 4 and FIG. 5 illustrate example wireless transmit and receive paths according to various embodiments of the present disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support flexible synchronization signal and system information transmission in wireless communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond and an RB can have a bandwidth of 180 KHz and include 12 SCs with inter-SC spacing of 15 KHz. A slot can be either full DL slot, or full UL slot, or hybrid slot similar to a special subframe in time division duplex (TDD) systems.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

A gNB transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE can determine CSI-RS transmission parameters through DL control signaling or higher layer signaling, such as a radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

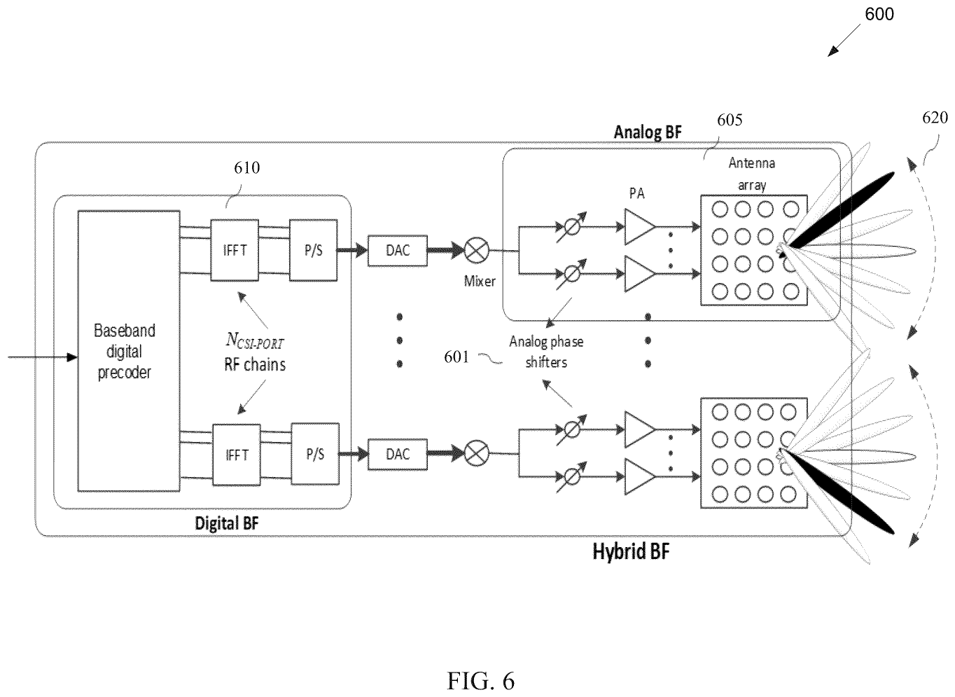

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example antenna structure 600 according to various embodiments of the present disclosure. An embodiment of the antenna structure 600 shown in FIG. 6 is for illustration only.

MIMO technologies have a key role in boosting system throughput both in NR and LTE and such a role will continue and further expand in the future generations of wireless technologies.

For MIMO operation, an antenna port is defined such that a channel over which a symbol on the antenna port is conveyed can be inferred from the channel over which another symbol on the same antenna port is conveyed. There is not necessarily a one to one correspondence between an antenna port and an antenna element, and a plurality of antenna elements can be mapped onto one antenna port.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks. Receiver operation can be conceived analogously.

To enable digital precoding, it is important to provide an efficient design of CSI-RS in order to address various operating conditions while maintaining a low overhead for CSI-RS transmissions. For that reason, three types of CSI reporting mechanism corresponding to three types of CSI-RS measurement behavior are supported in Rel. 13 LTE: 1) “CLASS A” CSI reporting that corresponds to non-precoded CSI-RS, 2) “CLASS B” CSI reporting with K=1 CSI-RS resource that corresponds to UE-specific beamformed CSI-RS, and 3) “CLASS B” reporting with K>1 CSI-RS resources that corresponds to cell-specific beamformed CSI-RS. For non-precoded (NP) CSI-RS, a cell-specific one-to-one mapping between CSI-RS port and TXRU is utilized.

Here, different CSI-RS ports have the same wide beam width and direction and hence generally cell-wide coverage. For beamformed CSI-RS, beamforming operation, either cell-specific or UE-specific, is applied on a non-zero-power (NZP) CSI-RS resource including multiple ports. Here, at least at a given time/frequency resources, CSI-RS ports have narrow beam widths, and hence do not provide cell-wide coverage, and (at least from the eNB perspective) at least some CSI-RS port-resource combinations have different beam directions. The basic principle remains same in NR.

In scenarios where a gNB can measure long-term DL channel statistics for a UE through receptions of signals from the UE, such as SRS or DM-RS, UE-specific beamformed CSI-RS can be readily used. This is typically feasible when UL-DL duplex distance is sufficiently small. When that condition does not hold, UE feedback is necessary for the gNB to obtain an estimate of long-term DL channel statistics (or any of its representation thereof). To facilitate such a procedure, a first beamformed CSI-RS transmitted with periodicity T1 (msec) and a second NP CSI-RS transmitted with periodicity T2 (msec), where T1≤T2. This approach is referred to as hybrid CSI-RS. The implementation of hybrid CSI-RS depends on the definition of CSI processes and NZP CSI-RS resources.

One important component of a MIMO transmission scheme is the accurate CSI acquisition at the gNB (or TRP). For MU-MIMO, in particular, availability of accurate CSI is necessary in order to guarantee robust MU performance and avoid interference among transmissions to different UEs. For TDD systems, CSI can be acquired using SRS transmissions from UEs by relying on DL/UL channel reciprocity. For FDD systems, a gNB can acquire CSI by transmitting CSI-RS and obtaining corresponding CSI reports from UEs. A CSI reporting framework can be “implicit” in the form of CQI/PMI/RI, and possibly CSI-RS resource indicator (CRI), as derived from a codebook assuming SU transmission from eNB. Because of the inherent SU assumption while deriving CSI, implicit CSI report is inadequate for MU transmissions. For MU-centric operation, a high-resolution Type-II codebook, in addition to low resolution Type-I codebook, can be used.

CSI refers to any of CRI, RI, length indicator (LI), PMI, CQI, reference signal received power (RSRP), or signal to interference noise ratio (SINR).

Present networks have limited capability to adapt an operation state in one or more of time/frequency/spatial/power domains. For example, in NR, there are transmissions or receptions on a cell by a serving gNB that are expected by UEs, such as transmissions of synchronization signals/physical broadcast channel (SS/PBCH) blocks, or of system information, or of CSI-RS indicated by higher layers, or receptions of physical random access channel (PRACH) or sounding reference signal (SRS) indicated by higher layers.

Reconfiguration of a NW operation state involves higher layer signaling by a system information block (SIB) or by UE-specific RRC. That is a slow process and requires substantial signaling overhead, particularly for UE-specific RRC signaling. For example, it is currently not practical or possible for a network in typical deployments to enter an energy saving operation state where the network does not transmit or receive due to low traffic on a cell as, in order to obtain material energy savings, the network needs to suspend transmissions or receptions for several tens of milliseconds and preferably for even longer time periods. A similar inability exists for suspending transmission or receptions on a cell for shorter time periods as a serving gNB may need to frequently transmit SS/PBCH blocks on the cell, such as every 5 msec or every 20 msec and, in time division duplex (TDD) systems with UL-DL configurations having few UL symbols in a period, the serving gNB may need to receive PRACH or SRS on the cell in most UL symbols in a period.

Due to the above reasons, adaptation of an operation state on a cell is typically over long time periods, such as for off-peak hours when an amount of served traffic is small and for peak hours when an amount of served traffic is large. Therefore, a capability of a gNB to improve service by fast adaptation of an operation state to the traffic types and load on a cell, or to save energy by switching to an operation state that requires less energy consumption when an impact on service quality may be limited or none on a cell, is currently limited as there are no procedures for a serving gNB to perform fast adaptation of an operation state with small signaling overhead while simultaneously informing all UEs of the operation state for a cell.

It is also beneficial to support a gradual transition of operation states on a cell between a maximum state where the cell operates at its maximum capability in one or more of a time/frequency/spatial/power domain and a minimum state where the cell operates at its minimum capability, or the cell enters a sleep mode. That may allow continuation of service while the cell transitions from a state with larger utilization of time/frequency/spatial/power resources to a state with lower utilization of such resources and the reverse as UEs can obtain time/frequency synchronization and automatic gain control (AGC) alignments, perform measurements and provide CSI reports or transmit SRS prior to scheduling of PDSCH receptions or PUSCH transmissions.

In order to enable a gNB to operate a cell on sleep state and save energy while minimizing an impact on served UEs on the cell, the gNB can apply discontinued transmissions (cell DTX) or discontinued receptions (cell DRX) on the cell, as an example operation state. A UE can be informed of corresponding cell DTX/DRX configurations for a cell such that the UE can operate accordingly and avoid power consumption when the cell is in a dormant state (cell DTX/DRX).

By turning off all or a part of a transmission chain and pausing transmission during the cell DTX, the gNB can reduce energy consumption for standby when there is little to no traffic on a cell. For cell DTX, a UE may assume that all transmissions from a serving gNB on the cell are suspended or the UE may assume that some signals, such as primary synchronization channel (PSS) or secondary synchronization channel (SSS) for maintaining synchronization, remain present during cell DTX. For example, the UE may not monitor PDCCH providing dynamic grants for PDSCH receptions or may not receive semi-persistent scheduled (SPS) PDSCH during cell DTX off-duration.

By turning off all or a part of receiver chain and pausing receptions during the cell DRX, the gNB can reduce energy consumption for standby on a cell when there is little to no traffic on the cell. For cell DRX, a UE may assume that all transmissions from the UE on a cell are suspended or may assume that some transmissions, such as ones required for initial access such as PRACH, are allowed during a cell DRX duration. During cell DRX off-duration, for example, the UE may not transmit configured grant (CG) PUSCH or a PUCCH with a scheduling request (SR) or a CSI report.

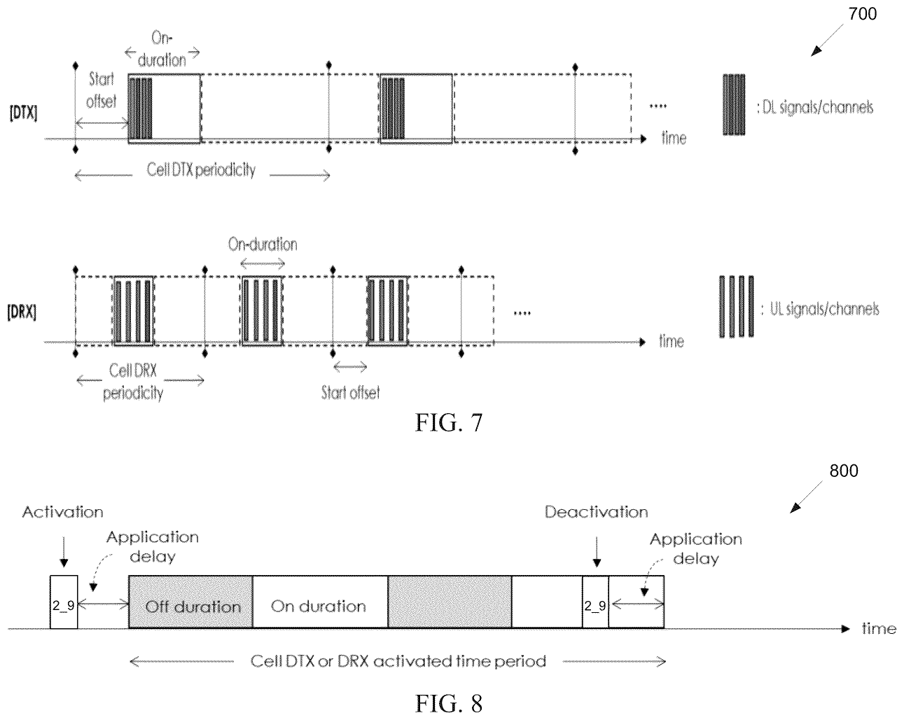

FIG. 7 illustrates an example of a cell DTX/DRX 700 according to various embodiments of the present disclosure. An embodiment of the cell DTX/DRX 700 shown in FIG. 7 is for illustration only.

As illustrated in FIG. 7, cell DTX/DRX can be configured via at least a periodicity, a start slot/offset, and an on-duration. A UE assumes that all transmissions/receptions by the gNB on a cell are enabled during the DTX/DRX on-duration, respectively. The configurations and operations of cell DTX and cell DRX can be linked or can be separate, for example depending on DL/UL traffic characteristics on the cell.

The general principle for adapting operation states on a cell includes a serving gNB indicating to a UE a set of operation states on the cell by higher layer signaling, such as by a SIB or UE-specific RRC signaling, and transmitting a PDCCH that provides a DCI format (DCI format 2_9) indicating one or more indexes from the set of operation states on the cell for the UE to determine an update of operation states.

FIG. 8 illustrates an example of a cell DTX/DRX activation/deactivation on a cell 800 according to various embodiments of the present disclosure. An embodiment of the cell DTX/DRX activation/deactivation on a cell 800 shown in FIG. 8 is for illustration only.

FIG. 8 illustrates an example of cell DTX/DRX activation/deactivation on a cell using DCI format 2_9. FIG. 8 illustrates an activation of a cell DTX or cell DRX upon receiving PDCCH providing DCI format 2_9 indicating activation after an application delay and deactivation of a cell DTX or cell DRX upon receiving PDCCH providing DCI format 2_9 indicating deactivation after an application delay. The application delay from the reception of PDCCH providing DCI format 2_9 until the activation or deactivation of an operation state on a cell can be predefined or provided to the UE via higher layer signaling.

Network operation parameters for a transmission or reception on a cell can be in one or more of a power, spatial, time, or frequency domain.

For example, in a power domain, a first NW operation state for a cell can be associated with a first value of parameter ss-PBCH-BlockPower providing an average energy per resource element (EPRE) with SSS in dBm, and a second NW operation state can be associated with a second value of a parameter ss-PBCH-BlockPower. For example, first and second NW operation states for a cell can be respectively associated with first and second values of parameter powerControlOffsetSS that provides a power offset (in dB) of non-zero power (NZP) CSI-RS RE to SSS RE. For example, first and second NW operation states for a cell can be respectively associated with first and second values of parameter powerControlOffset that provides a power offset (in dB) of PDSCH RE to NZP CSI-RS RE.

For example, in a frequency domain, first and second NW operation states for a cell can be respectively associated with first and second values of a parameter locationAndBandwidth that indicates a frequency domain location and a bandwidth for receptions or transmissions by a UE on the cell. For example, first and second NW operation states for a cell can be respectively associated with first and second values of a parameter BWP-Id for an active DL BWP or an active UL on the cell. For example, first and second NW operation states can be respectively associated with first and second values of a list of cells for active transmission and reception. The cells can be serving cells or non-serving cells for example in case of mobility.

For example, in a spatial domain, first and second NW operation states for a cell can be respectively associated with first and second values of a parameter maxMIMO-Layers that indicates a maximum number of MIMO layers to be used for PDSCH receptions by a UE in the associated active DL BWP of the cell, or with first and second values of a parameter nrOfAntennaPorts that indicates a number of antenna ports to be used for codebook determination for PDSCH receptions on the cell, or with first and second values of a parameter activeCoresetPoolIndex for coresetPoolIndex values for PDCCH reception in corresponding CORESETs on the cell and the UE can skip PDCCH receptions in a CORESET with a coresetPoolIndex value that is not indicated by activeCoresetPoolIndex. For example, first and second NW operation states for a cell can be respectively associated with first and second values of an antenna port subset that indicates a list of active antenna ports for CSI calculation and other associated parameters such as codebook subset restriction, rank restriction, the logical antenna size in a two-dimension, number of antenna ports, and a list of CSI-RS resources, etc., for the cell.

For example, in a time domain, first and second NW operation states for a cell can be respectively associated with first and second values of a parameter ssb-PeriodicityServingCell that indicates a transmission periodicity in milliseconds for SS/PBCH blocks on the cell, or with first and second values of a parameter ssb-PositionsInBurst that indicates time domain positions of SS/PBCH blocks in a SS/PBCH block transmission burst on the cell, or with first and second values of a parameter groupPresence that indicates groups of SS/PBCH blocks, such as groups of four SS/PBCH blocks with consecutive indexes, that are transmitted on the cell. For example, first and second NW operation states for a cell can be respectively associated with first and second values of a time pattern, e.g., in terms of periodicity, on-duration, start offset, etc., that indicates cell discontinuous transmission (DTX) or cell discontinuous reception (DRX) for the cell.

The legacy SSB transmission interval has a fixed periodicity. Such a fixed SSB periodicity and subsequent SIBs, such as SIB1 scheduled by MIB and other SIBs scheduled by SIB1, limits the flexibility of network adaptation in time domain. Therefore, there is a need to define procedures and methods for a UE to receive flexibly transmitted SSBs and/or SIBs for enhancing network energy saving in time domain. Furthermore, there is a need to define procedures and methods for a UE to request a serving gNB to provide SSB and/or SIBs, e.g., by transmitting wake-up signal (WUS), and for a UE to receive SSB and/or SIB transmitted by the serving gNB based on demand.

Depending on the operation state on a cell, e.g., in a cell DTX/DRX on-duration or off-duration, the serving gNB may want to transmit SSB and/or SIBs with different periodicities or may want to adapt the availability of SSB and/or SIBs during cell DTX/DRX off-durations. Therefore, there is another need to define procedures and methods for a UE to receive SSB and/or SIBs with different periodicities or with varying availabilities depending on the current operation state on a cell.

When considering UEs in an RRC-IDLE state or an RRC-INACTIVE state, the SSB and/or SIBs cannot be completely based on demand or having varying availabilities. Therefore, there is a need to define procedures and methods for a UE to receive multiple different types of SSB and/or SIBs transmitted with different periodicities and/or adaptabilities.

The present disclosure relates to a communication system. The disclosure relates to defining functionalities and procedures for adapting transmission periodicity or availability of SSB and/or SIBs in order to achieve network energy savings for the cell.

The present disclosure further relates to defining procedures and methods for a UE to receive flexibly transmitted SSBs and/or SIBs in time domain on a cell.

The present disclosure further relates to defining procedures and methods for a UE to request a serving gNB to provide SSB and/or SIBs, e.g., by transmitting wake-up signal (WUS), and for a UE to receive SSB and/or SIBs transmitted based on demand.

The present disclosure additionally relates to defining procedures and methods for a UE to receive SSB and/or SIBs with different periodicities or with varying availabilities depending on the current operation state on a cell.

The present disclosure further relates to defining procedures and methods for a UE to receive multiple different types of SSB and/or SIBs transmitted with different periodicities and/or adaptabilities.

The present disclosure provides method and apparatus for defining procedures and methods for a UE to receive flexibly transmitted SSBs and/or SIBs in time domain on a cell.

The present disclosure provides method and apparatus for defining procedures and methods for a UE to request a serving gNB to provide SSB and/or SIBs, e.g., by transmitting wake-up signal (WUS), and to receive SSB and/or SIB transmitted based on demand.

The present disclosure provides method and apparatus for defining procedures and methods for a UE to receive SSB and/or SIBs with different periodicities or with varying availabilities depending on the current operation state on a cell.

The present disclosure provides method and apparatus for defining procedures and methods for a UE to receive multiple different types of SSB and/or SIBs transmitted with different periodicities and/or adaptabilities.

The general principle for adapting transmission periodicity or availability of SSB and/or SIBs, for example in order to support network energy savings for the cell, includes transmissions by a serving gNB and receptions by a UE of multiple different types of SSBs having different periodicities and/or adaptabilities on its availability, or SIBs. Different types of SSBs/SIBs may have different periodicities and/or adaptabilities depending on the target use case and applicable operation states on a cell.

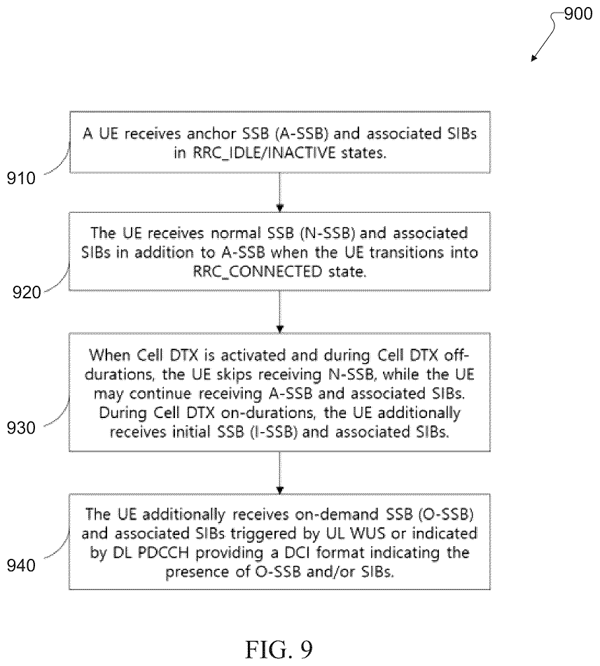

FIG. 9 illustrates an example method 900 performed by a UE for receiving multiple different types of SSBs and/or SIBs according to various embodiments of the present disclosure. The method 900 of FIG. 9 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 900 is for illustration only and other embodiments can be used without departing from the scope of the present disclosure.

As illustrated in FIG. 9, a UE receives an anchor SSB (A-SSB) and associated SIBs in RRC_IDLE or RRC_INACTIVE state (910). The A-SSB is transmitted with a fixed periodicity, and a UE can assume the presence of A-SSBs at its occasions. The A-SSB can be also received by a UE in an RRC_CONNECTED state. From a UE perspective, the A-SSB is always guaranteed to be transmitted regardless of the current operation state on a cell, such as whether a cell is in Cell DTX/DRX off-durations, etc. For example, if a UE is configured with an SSB-based measurement timing configuration (SMTC), the UE expects the availability of A-SSBs in SMTC according to the provided SMTC window configuration in terms of periodicity and offset. The A-SSB transmission configuration, including ssb-PositionInBurst, ssb-PeriodicityServingCell and ss-PBCH-BlockPower, can be provided to a UE via higher layer signaling such as SIB or UE-specific RRC signaling. The maximum periodicity of A-SSB can be larger than or equal to the periodicities of legacy SSB, such as 320 ms, 640 ms, 1280 ms, etc.

The UE receives a normal SSB (N-SSB) and associated SIBs in addition to A-SSB when the UE transitions into RRC_CONNECTED state (920). The N-SSB is transmitted with a fixed periodicity but the UE may not always assume the presence of N-SSB at its occasions. For instance, the presence of N-SSB at its occasions may depend on the current operation state on a cell. As one example, the N-SSB is transmitted when the Cell DTX is deactivated or during Cell DTX on-durations, while the N-SSB may not be transmitted and, thus, the UE does not expect to receive N-SSB during Cell DTX off-durations on a cell. The N-SSB transmission configuration, including ssb-PositionInBurst, ssb-PeriodicityServingCell and ss-PBCH-BlockPower, can be provided to a UE via higher layer signaling such as SIB or UE-specific RRC signaling. The maximum periodicity of N-SSB can be relatively smaller than that of A-SSB and the possible N-SSB periodicities may be identical with the legacy values, e.g., 5, 10, 20, 40, 80, 160 ms. In one example, the periodicity of N-SSB can be an integer fraction, e.g., 1/K where K is a positive integer, of the periodicity of A-SSB.

Furthermore, their occasions may be aligned, i.e., every K N-SSB occasion coincides with an A-SSB occasion. When an A-SSB occasion and an N-SSB occasion coincide, only one type of SSB, either A-SSB or N-SSB, is transmitted. In one example, A-SSB is transmitted when its occasion overlaps or coincides with an occasion of other SSB types. In another example, the N-SSB transmission configuration may be unrelated and independently provided to a UE from that of an A-SSB. When a N-SSB occasion is within a certain time duration from a preceding A-SSB occasion or within a certain time duration to a following A-SSB occasion, the N-SSB may not be transmitted.

Alternatively, the N-SSB is transmitted regardless of A-SSB occasions unless the occasions of the two are overlapping. If there is an overlap between the two SSB occasions of different types, in one example, the A-SSB has higher priority over N-SSB, i.e., A-SSB is transmitted and N-SSB is dropped. Alternatively, the N-SSB has higher priority over A-SSB, i.e., N-SSB is transmitted and A-SSB is dropped. The serving gNB may configure a N-SSB such that at least one N-SSB is included in every cell DTX on-duration. If N-SSB occasion lies on a boundary between cell DTX on-duration and off-duration, i.e., one or multiple symbols of N-SSB, but not all, fall in a cell DTX off-duration, N-SSB is transmitted completely.

When cell DTX is activated and during cell DTX off-durations, the UE skips receiving N-SSB, while the UE may continue to expect the presence of A-SSB and associated SIBs. During cell DTX on-durations, the UE additionally receives initial SSB (I-SSB) and associated SIBs (930). Although the UE may assume the presence of A-SSB and its associated SIBs during cell DTX off-durations, the UE may or may not perform detection of A-SSB and subsequent synchronization during cell DRX off-durations, which may be indicated to the UE by the serving gNB or left up to UE decision. When the serving gNB transitions from a cell DTX off-duration to an on-duration, the I-SSB provided with each cell DTX on-duration allows UEs to acquire fast time/frequency synchronization with the start of on-duration.

In one example, the I-SSB is transmitted prior to the start of cell DTX on-durations, i.e., the I-SSB is transmitted at the end of the preceding cell DTX off-duration and it is not a part of cell DTX on-duration. There may be a certain time gap from the last symbol occupied by I-SSB to the start of the following cell DTX on-duration. Such a time gap may be predefined in the specifications of the system operation or indicated to the UE via higher layer signaling such as SIB or UE-specific RRC signaling. The time gap may be defined or indicated to UEs in a number of symbols. Alternatively, the I-SSB is provided with the start of every cell DTX on-durations with or without a time gap from the start of the corresponding cell DTX on-duration. Similarly, such a time gap may be predefined or signaled to the UE.

The UE additionally receives on-demand SSB (O-SSB) and/or SIBs triggered by UL WUS. The UE may be indicated by a serving gNB via PDCCH providing a DCI format indicating the presence of O-SSB and/or SIBs (940). The O-SSB/SIB does not have a fixed periodicity and it is triggered by a request from one or more UEs based on demand. In one example, the O-SSB/SIB can be requested by a UE and/or transmitted by a serving gNB only during cell DTX and/or DRX off-durations. In another example, the O-SSB/SIB can be requested by a UE and/or transmitted by a serving gNB during both cell DTX/DRX off-durations and on-durations, as well as when the cell DTX/DRX is deactivated. In one example, if an O-SSB/SIB occasion overlaps with an occasion of other SSB/SIB types or within a certain time duration to or from an occasion of other SSB/SIB types, the O-SSB/SIB is not transmitted, i.e., the O-SSB/SIB has lower priority to other SSB types.

If an A-SSB/SIB occasion overlaps with occasions of any other SSB/SIB types, a UE assumes that the A-SSB/SIB is transmitted while the other SSB/SIB types whose occasions overlap with the A-SSB/SIB are dropped. Similarly, if occasions of any other SSB/SIB types are within a certain time duration to or from an A-SSB/SIB occasion, a UE assumes that the other SSB/SIB types other than A-SSB/SIB are dropped. If an occasion of I-SSB/SIB and an occasion of N-SSB/SIB overlap either partially or fully, or if they are within a certain time duration from each other, a UE assumes that the I-SSB/SIB is transmitted while the N-SSB/SIB is dropped. Alternatively, if an occasion of I-SSB/SIB and an occasion of N-SSB/SIB overlap either partially or fully, or if they are within a certain time duration from each other, a UE assumes that the N-SSB/SIB is transmitted while the I-SSB/SIB is dropped.

In yet another example, if occasions of any two SSBs/SIBs, having either the same type or different types, are within a certain time duration from each other, a UE assumes that the SSB/SIB having an occasion earlier in time, i.e., the preceding one, is transmitted, while the SSB/SIB having an occasion later in time, i.e., the following one, is not transmitted.

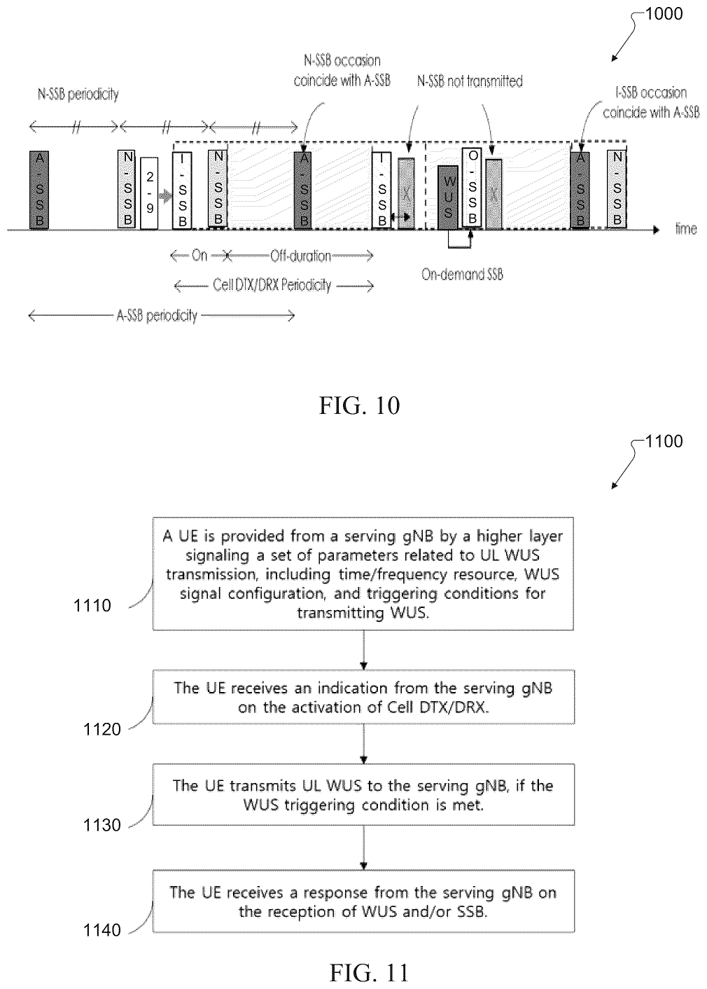

FIG. 10 illustrates an example of network adaptation 1000 with multiple different types of SSBs/SIBs according to various embodiments of the present disclosure. The network adaptation 1000 is for illustration only and other embodiments can be used without departing from the scope of the present disclosure.

In FIG. 10, the periodicity of A-SSB/SIB is three times of that of N-SSB/SIB and their occasions are aligned, i.e., occasions of A-SSB/SIB always coincide with every third occasion of N-SSB/SIB. The A-SSBs/SIBs are always transmitted at their predetermined occasions regardless of the current operation state on a cell, such as whether the cell DTX/DRX is activated or not and whether it is cell DTX/DRX on-duration or off-duration, when activated. Therefore, the A-SSB/SIB can be received by UEs in any RRC states, i.e., RRC_CONNECTED, RRC_IDLE, or RRC_INACTIVE. The N-SSB/SIB is also transmitted with a fixed periodicity, like A-SSB/SIB, but with a certain adaptability. The N-SSB/SIB is intended to provide more frequent synchronization opportunities for RRC_CONNECTED UEs.

As illustrated in FIG. 10, the N-SSB/SIB may not be always transmitted as defined by its periodic occasions if an occasion overlaps with other higher priority SSB/SIB types, if an occasion falls in a cell DTX off-duration, or if an occasion follows earlier transmitted SSB/SIB within a certain time duration. Therefore, a UE does not always assume the presence of N-SSB/SIB at its periodic occasions. From the figure, it can be also seen that I-SSBs/SIBs are transmitted with every cell DTX on-durations, to provide a synchronization opportunity with the start of cell DTX on-durations, except when its occasion overlaps with A-SSB/SIB. It can be also seen that O-SSB/SIB is triggered by a request from a UE based on demand and transmitted by a serving gNB during cell DTX off-durations.

The general principle for a UE-initiated cell reactivation for a cell in cell DTX/DRX off-durations includes a UE transmitting UL WUS when certain triggering conditions are met and a serving gNB transmitting a message in response to the reception of the UL WUS. The serving gNB may respond by transmitting SSB and/or a PDCCH providing a certain DCI format scheduling a PDSCH providing a response/SIB message.

FIG. 11 illustrates an example method 1100 performed by a UE for initiating cell activation according to various embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

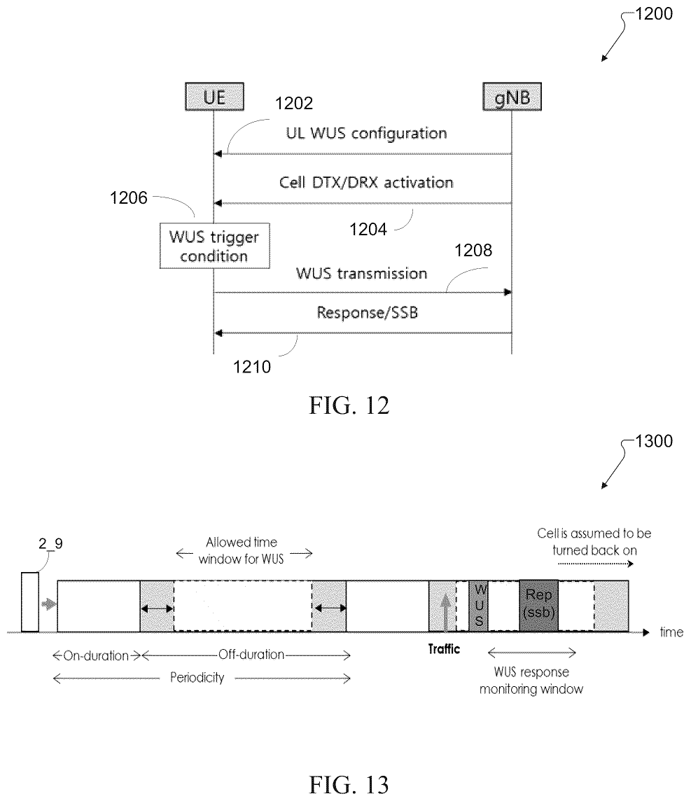

FIG. 12 illustrates a signaling flow 1200 for UE-initiated cell reactivation according to various embodiments of the present disclosure. The signaling flow 1200 is for illustration only and other embodiments can be used without departing from the scope of the present disclosure. The signaling flow 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The signaling flow 1200 is for illustration only and other embodiments can be used without departing from the scope of the present disclosure.

As illustrate in FIG. 12, in step 1202, a gNB sends UL WUS configuration to a UE. In step 1204, the gNB sends cell DTX/DRX activation to the UE. In step 1206, the UE determines whether the WUS trigger condition is met. In step 1208, the UE sends the WUS transmission to the gNB. In step 1210, the gNB sends the response/SSB to the UE.

FIG. 13 illustrates an example of transmission of UL WUS of UE and response of gNB 1300 according to various embodiments of the present disclosure. The transmission of UL WUS of UE and response of gNB 1300 is for illustration only and other embodiments can be used without departing from the scope of the present disclosure.

As illustrated in FIG. 11, a UE is provided from a serving gNB by a higher layer signaling a set of parameters related to UL WUS transmission, including time/frequency resource, WUS signal configuration, and triggering conditions for transmitting WUS (1110). The higher layer signaling can be a SIB or UE-specific RRC signaling. The UE is provided parameters for time domain resources for WUS transmission such as periodicity and offset defining periodic WUS transmission occasions. Furthermore, WUS transmissions by a UE may be allowed only for a certain time duration, such as cell DTX and/or DRX off-durations, during which the cell is in dormancy. The UE may be also indicated a number of symbols occupied by WUS transmission. When the indicated WUS transmission duration is longer than the duration of WUS signal itself, the UE may be indicated to perform beam sweeping or repetition when transmitting WUS.

Alternatively, the UE may be allowed to select either beam sweeping or repetition based on its own decision. The UE is also provided parameters for frequency domain resources for WUS transmission such as a certain frequency range for WUS transmission, including a starting frequency, e.g., PRB index, startPRB, and a bandwidth, e.g., number of PRBs, nrofPRBs. The UE may be also indicated one or more indexes of serving cells on which the WUS transmissions are allowed. The UE also is provided parameters for WUS signal configuration, which includes a type of WUS. An UL WUS may be based on one or more of existing signals or channels such as scheduling request (SR) using PUCCH, PRACH preambles, and SRS.

The UE receives an indication from the serving gNB on the activation of Cell DTX/DRX (1120). As illustrated in FIG. 13, a cell DTX/DRX is activated upon receiving PDCCH providing DCI format 2_9 indicating activation after an application delay. As described in Step 1110, when cell DTX/DRX is activated, the UE may be allowed to transmit the WUS during cell DTX and/or DRX off-durations. When WUS occasions fall in a cell DTX and/or DRX on-durations or when cell DTX/DRX is deactivated upon receiving PDCCH providing DCI format 2_9 indicating deactivation after an application delay, the UE shall not transmit WUS at its periodic occasions and even when other triggering conditions are met.

The UE transmits UL WUS to the serving gNB, if the WUS triggering condition is met (1130). The triggering condition may be predefined in the specifications of the system operation or indicated to the UE via higher layer signaling such as SIB or UE-specific RRC signaling. The triggering condition may be provided in terms of traffic such as arrivals of certain traffic types, logical channels, logical channel groups, buffered traffic volume, and latency requirement of packets.

The UE receives a response/SIB from the serving gNB on the reception of WUS and/or SSB (1140). The UE expects to receive a response from the serving gNB within a WUS response monitoring window, which may be predefined in the specifications of the system operation or indicated to the UE via higher layer signaling such as SIB or UE-specific RRC in number of slots or ms, as illustrated in FIG. 13. The WUS response monitoring window may start from the end of WUS transmission. Alternatively, the WUS response monitoring window may start from the first PDCCH monitoring occasion for a DCI format scheduling a PDSCH providing a response message or from the first periodic SSB occasions.

Further alternatively, the WUS response monitoring window may start after a certain offset from the end of WUS transmission, which is predefined in the specifications of the system operation or indicated to the UE via higher layer signaling, and last for a certain indicated or predefined time duration in number of slots or ms. The PDCCH providing a DCI format scheduling a PDSCH providing a response/SIB message or SSB in response to the WUS reception may be transmitted by the serving gNB at any time, not subject to their periodic occasions, during the WUS response monitoring window. Therefore, the UE may continuously monitor a response from the serving gNB during the WUS response monitoring window.

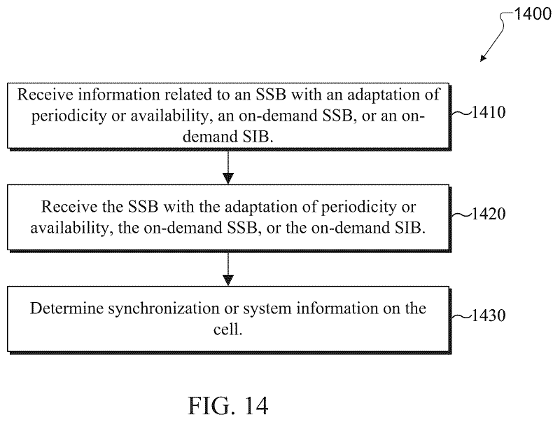

FIG. 14 illustrates an example method 1400 performed by a UE in a wireless communication system according to embodiments of the present disclosure. The method 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The method 1400 begins with the UE receiving information related to: an SSB with an adaptation of periodicity or availability, an on-demand SSB, or an on-demand SIB (1410). In various embodiments, the UE receives an activation of the on-demand SSB or the on-demand SIB via a PDCCH providing a DCI format.

The UE then receives the SSB with the adaptation of periodicity or availability, the on-demand SSB, or the on-demand SIB on the cell (1420). For example, in 1420, the UE receives the SSB with a first periodicity in a cell DTX active period and receives the SSB with a second periodicity in a cell DTX non-active period. In another example, the UE receives the SSB with a periodicity in the cell DTX active period and does not receive any SSB in a cell DTX non-active period. The UE then determines synchronization or system information on the cell (1430).

In various embodiments, the UE receives information related to transmission of a WUS and transmits the WUS based on the information related to the WUS transmission. The information related to the WUS transmission includes at least a time and frequency resource for the WUS transmission. The WUS is based on PRACH preambles. The UE then receives the on-demand SSB or the on-demand SIB. In various embodiments, the UE receives information related to transmission of a WUS including one or more triggering conditions for transmitting the WUS and transmits the WUS when at least one of the one or more triggering conditions is met. For example, the one or more triggering conditions are based on a packet arrival of a certain traffic type, a certain logical channel, or a certain logical channel group, a volume of buffered traffic, or a latency requirement of traffic.

In various embodiments, the UE transmits a WUS and receives a DCI format scheduling a PDSCH providing the on-demand SIB in response to the WUS transmission by monitoring a PDCCH providing the DCI format. A monitoring window for monitoring the PDCCH is determined based on a transmission time of the WUS transmission.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE), the method comprising:
receiving information related to:
a synchronization signal block (SSB) with an adaptation of periodicity or availability,
an on-demand SSB, or
an on-demand system information block (SIB);
receiving, on a cell, (i) the SSB with the adaptation of periodicity or availability, (ii) the on-demand SSB, or (iii) the on-demand SIB; and
determining synchronization or system information on the cell.

2. The method of claim 1, wherein receiving (i) the SSB with the adaptation of periodicity or availability, (ii) the on-demand SSB, or (iii) the on-demand SIB comprises:
receiving the SSB with a first periodicity in a cell discontinuous transmission (DTX) active period, and
receiving the SSB with a second periodicity in a cell DTX non-active period.

3. The method of claim 1, wherein receiving (i) the SSB with the adaptation of periodicity or availability, (ii) the on-demand SSB, or (iii) the on-demand SIB comprises:
receiving the SSB with a periodicity in a cell discontinuous transmission (DTX) active period, and
receiving no SSB in a cell DTX non-active period.

4. The method of claim 1, further comprising:
receiving information related to transmission of a wake-up signal (WUS), wherein:
the information related to transmission of the WUS includes at least a time and frequency resource for transmission of the WUS, and
the WUS is based on physical random access channel (PRACH) preambles; and
transmitting the WUS based on the information related to transmission of the WUS,
wherein receiving (i) the SSB with the adaptation of periodicity or availability, (ii) the on-demand SSB, or (iii) the on-demand SIB comprises receiving the on-demand SSB or the on-demand SIB.

5. The method of claim 1, further comprising receiving, via a downlink control information (DCI) format, an activation of the on-demand SSB or the on-demand SIB.

6. The method of claim 1, further comprising:
receiving information related to transmission of a wake-up signal (WUS) including one or more triggering conditions for transmitting the WUS, wherein the one or more triggering conditions are based on:
a packet arrival of a certain traffic type, a certain logical channel, or a certain logical channel group,
a volume of buffered traffic, or
a latency requirement of traffic; and
transmitting the WUS when at least one of the one or more triggering conditions is met.

7. The method of claim 1, further comprising:
transmitting a wake-up signal (WUS); and
receiving a downlink control information (DCI) format scheduling a physical downlink shared channel (PDSCH) providing the on-demand SIB in response to transmission of the WUS by monitoring a physical downlink control channel (PDCCH) providing the DCI format,
wherein a monitoring window for monitoring the PDCCH is determined based on a transmission time of the WUS.

8. A user equipment (UE), comprising:
a transceiver configured to:
receive information related to:
a synchronization signal block (SSB) with an adaptation of periodicity or availability,
an on-demand SSB, or
an on-demand system information block (SIB); and
receive, on a cell, (i) the SSB with the adaptation of periodicity or availability, (ii) the on-demand SSB, or (iii) the on-demand SIB; and
a processor operably coupled with the transceiver, the processor configured to determine synchronization or system information on the cell.

9. The UE of claim 8, wherein the transceiver is further configured to:
receive the SSB with a first periodicity in a cell discontinuous transmission (DTX) active period, and
receive the SSB with a second periodicity in a cell DTX non-active period.

10. The UE of claim 8, wherein the transceiver is further configured to:
receive the SSB with a periodicity in a cell discontinuous transmission (DTX) active period, and
receive no SSB in a cell DTX non-active period.

11. The UE of claim 8, wherein the transceiver is further configured to:
receive information related to transmission of a wake-up signal (WUS), wherein:
the information related to transmission of the WUS includes at least a time and frequency resource for transmission of the WUS, and
the WUS is based on physical random access channel (PRACH) preambles;
transmit the WUS based on the information related to transmission of the WUS; and
receive the on-demand SSB or the on-demand SIB.

12. The UE of claim 8, wherein the transceiver is further configured to receive, via downlink control information (DCI) format, an activation of the on-demand SSB or the on-demand SIB.

13. The UE of claim 8, wherein the transceiver is further configured to:
receive information related to transmission of a wake-up signal (WUS) including one or more triggering conditions for transmitting the WUS, wherein the one or more triggering conditions are based on:
a packet arrival of a certain traffic type, a certain logical channel, or a certain logical channel group,
a volume of buffered traffic, or
a latency requirement of traffic; and
transmit the WUS when at least one of the one or more triggering conditions is met.

14. The UE of claim 8, wherein:
the transceiver is further configured to:
transmit a wake-up signal (WUS); and
receive a downlink control information (DCI) format scheduling a physical downlink shared channel (PDSCH) providing the on-demand SIB in response to transmission of the WUS by monitoring a physical downlink control channel (PDCCH) providing the DCI format, and
a monitoring window for monitoring the PDCCH is determined based on a transmission time of the WUS.

15. A base station (BS), comprising:
a processor; and
a transceiver operably coupled with the processor, the transceiver configured to:
transmit information related to:
a synchronization signal block (SSB) with an adaptation of periodicity or availability;
an on-demand SSB, or
an on-demand system information block (SIB); and
transmit (i) the SSB with the adaptation of periodicity or availability, (ii) the on-demand SSB, or (iii) the on-demand SIB.

16. The BS of claim 15, wherein the transceiver is further configured to:
transmit the SSB with a first periodicity in a cell discontinuous transmission (DTX) active period, and
transmit the SSB with a second periodicity in a cell DTX non-active period.

17. The BS of claim 15, wherein the transceiver is further configured to:
transmit the SSB with a periodicity in a cell discontinuous transmission (DTX) active period, and
transmit no SSB in a cell DTX non-active period.

18. The BS of claim 15, wherein the transceiver is further configured to:
transmit information related to reception of a wake-up signal (WUS), wherein:
the information related to reception of the WUS includes at least a time and frequency resource for the reception of WUS, and
the WUS is based on physical random access channel (PRACH) preambles;
receive the WUS; and
transmit the on-demand SSB or the on-demand SIB.

19. The BS of claim 15, wherein the transceiver is further configured to transmit, via a downlink control information (DCI) format, an activation of the on-demand SSB or the on-demand SIB.

20. The BS of claim 15, wherein the transceiver is further configured to:
transmit information related to reception of a wake-up signal (WUS) including one or more triggering conditions for the WUS, wherein the one or more triggering conditions are based on:
a packet arrival of a certain traffic type, a certain logical channel, or a certain logical channel group,
a volume of buffered traffic, or
a latency requirement of traffic; and
receive the WUS when at least one of the one or more triggering conditions is met.
